(19) United States
(12) Patent Application Publication
(10) Pub. No.: US 2018/0062229 A1
(43) Pub. Date: Mar. 1, 2018

(54) COOLING STRUCTURE FOR BATTERY CELL OF VEHICLE

(71) Applicant: Hyundai Motor Company, Seoul (KR)

(72) Inventor: Byung Jo Jeong, Seoul (KR)

(21) Appl. No.: 15/355,023

(22) Filed: Nov. 17, 2016

(30) Foreign Application Priority Data
Aug. 31, 2016 (KR) 10-2016-0111409

(51) Int. Cl. H01M 10/6563; H01M 10/613; H01M 10/625; H01M 2/10

(52) U.S. Cl. CPC H01M 10/6563; H01M 10/613; H01M 2220/20; H01M 2/1077; H01M 10/625

(57) ABSTRACT

A cooling structure for a battery cell includes: a plurality of cells that are stacked; lead tabs protruding outwardly from both ends of the cells to form positive or negative electrodes; and a duct disposed outside of the lead tabs and providing cooling air to the lead tabs to cool the lead tabs. While cooling performance in a battery structure for a vehicle may be maintained by cooling the lead tabs using the cooling air through the duct, durability may be improved by stacking the cells and energy density with respect to the weight and volume of the battery structure, without requiring a heat sink plate and a cooling channel that are conventionally used.

### CROSS-REFERENCE TO RELATED APPLICATION

This application claims under 35 U.S.C. §119(a) the benefit of Korean Patent Application No. 10-2016-0111409, filed on Aug. 31, 2016 in the Korean Intellectual Property Office, the entire contents of which are incorporated by reference herein.

### BACKGROUND

### (a) Technical Field

The present disclosure relates to a cooling structure for a battery cell, and, more particularly, to a cooling structure for a battery cell for improving energy density by minimizing the volume while maintaining cooling performance in a battery structure for a vehicle.

### (b) Description of the Related Art

In general, secondary batteries are classified into a can-type secondary battery having an electrode assembly embedded in a metal can and a pouch-type secondary battery having an electrode assembly embedded in a pouch of an aluminum laminate sheet, according to shapes of exterior materials.

Recently, the secondary batteries have extensively been used in medium- and large-sized devices such as vehicles and energy storage systems, as well as in small-sized devices such as portable electronic devices.

When used in medium- and large-sized devices, a number of secondary batteries may be electrically connected so as to increase capacity and output. In particular, pouch-type secondary batteries may be largely used in medium- and large-sized devices since they are easily stacked and are lightweight.

However, since the pouch-type secondary battery is commonly packed in a battery case of a laminate sheet made of aluminum and polymer resin, mechanical rigidity thereof is low. When a plurality of pouch-type secondary batteries constitute a battery module, it is not easy to maintain a stacked state by themselves, and thus, cartridges are usually used for protecting the secondary batteries from external impact, preventing the moving of the secondary batteries, and facilitating the stacking operation.

The cartridge commonly has a quadrangular plate form which is hollow in the middle. Here, four sides of the cartridge may envelop the circumference of the pouch-type secondary battery. A plurality of cartridges may be stacked to constitute the battery module, and the secondary batteries may be positioned in an inner hollow space that is formed when the cartridges are stacked.

Meanwhile, conventional battery modules have utilized various methods such as direct or indirect water cooling and air cooling, in order to ensure good cooling performance. However, in order to remove heat generated when the conventional battery modules are charged or discharged, a space for cooling may be provided or a cooling member may be additionally combined.

In particular, conventional cooling methods have largely utilized a cooling member made of a metallic material such as a cell cover or a cooling plate (i.e., a heat sink plate) for refrigerant flow or thermal conduction.

However, when the cooling member or the space for cooling is additionally provided, there is an increase in the entire volume of the battery module. Thus, the complexity of the battery module is increased, and processing capabilities may be reduced, such that the overall size is increased, which is undesirable from the perspective of promoting miniaturization. In addition, manufacturing costs and time may also be increased.

### SUMMARY

An aspect of the present disclosure provides a cooling structure for a battery cell for improving energy density by minimizing the volume while maintaining cooling performance in a battery structure for a vehicle.

According to an aspect of the present disclosure, a cooling structure for a battery cell, includes: a plurality of cells that are stacked; lead tabs protruding outwardly from both ends of the cells to form positive or negative electrodes; and a duct disposed outside of the lead tabs and providing cooling air to the lead tabs to cool the lead tabs.

The plurality of cells may be attached to each other to form a parallel structure.

The lead tabs may include a plurality of cooling holes so as to introduce the cooling air introduced through the duct to the lead tabs.

The cooling holes may have a quadrangular shape, and a guide may be provided in a direction in which the cooling air moves.

One end of the lead tab may be welded to the interior of the cell, and a sealing member may be provided outside of the lead tab to seal the cell and the lead tab.

The lead tabs may be formed of positive and negative terminals.

The plurality of cooling holes may be disposed in the same positions in the positive and negative terminals to form a heat dissipation path using the cooling air introduced through the duct.

According to another aspect of the present disclosure, a cooling structure for a battery cell, includes: a plurality of cells that are stacked; lead tabs protruding outwardly from both ends of the cells to form positive or negative electrodes and including a plurality of cooling holes; and a duct disposed outside of the lead tabs and providing cooling air to the cooling holes of the lead tabs to form a heat dissipation path and cool the lead tabs.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view of a cooling structure for a battery cell, according to an exemplary embodiment of the present disclosure;

FIG. 2 illustrates a cross-sectional view of cells and lead tabs stacked in a cooling structure for a battery cell, according to an exemplary embodiment of the present disclosure;

FIG. 3 illustrates a cell and a lead tab in a cooling structure for a battery cell, according to an exemplary embodiment of the present disclosure;

FIG. 4 illustrates a cross-sectional view of a lead tab in a cooling structure for a battery cell, according to an exemplary embodiment of the present disclosure;

FIG. 5 illustrates a cross-sectional view of a lead tab having circular cooling holes in a cooling structure for a battery cell, according to an exemplary embodiment of the present disclosure; and

FIG. 6 illustrates a cross-sectional view of a lead tab having quadrangular cooling holes in a cooling structure for a battery cell, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-of”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described in detail with reference to the accompanying drawings.

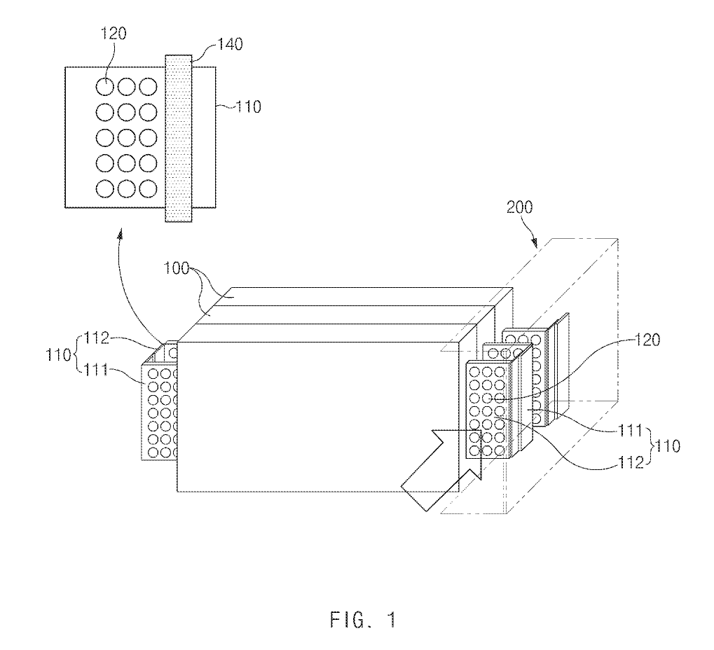

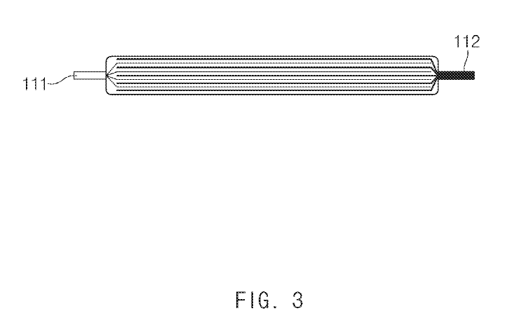

As illustrated in FIGS. 1 to 3, a cooling structure for a battery cell, according to an exemplary embodiment of the present disclosure, includes a plurality of cells 100, lead tabs 110 disposed on both ends of the cells 100, and a duct 200 cooling the lead tabs 110.

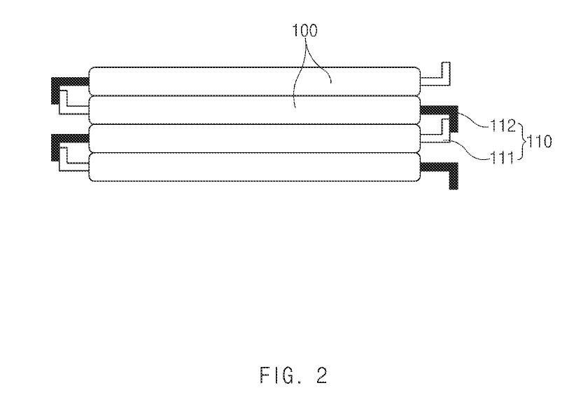

As illustrated in FIGS. 1 and 2, the plurality of cells 100 may be stacked to form a parallel structure.

In particular, the plurality of cells 100 may be attached to each other to form the parallel structure such that no space is formed between the cells 100.

As illustrated in FIGS. 2 to 4, the lead tabs 110 may protrude outwardly from both ends of the cells 100 to form positive or negative electrodes.

The duct 200 may be disposed outside of the lead tabs 110 to provide cooling air to the lead tabs 110, thereby cooling the lead tabs 110.

Preferably, a blower (not shown) providing the cooling air to the duct may be disposed outside of the duct, and the duct and the blower may be connected to each other.

In order to introduce the cooling air introduced through the duct 200 to the lead tabs 110, a plurality of cooling holes 120 may be provided in the lead tabs 110.

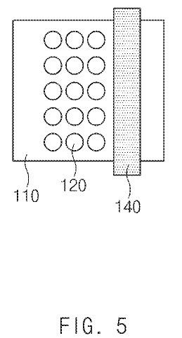

Meanwhile, the cooling holes 120 may have a circular shape as illustrated in FIGS. 1 and 5, and may also have different shapes.

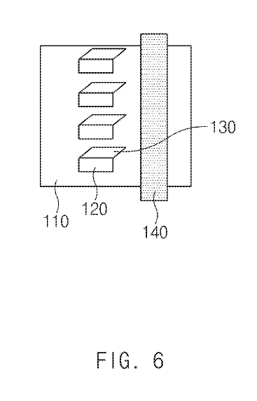

For example, the cooling holes 120 may have a quadrangular shape as illustrated in FIG. 6. When the cooling holes 120 have a quadrangular shape, a guide 130 may be provided in a direction in which the cooling air moves, thereby facilitating the flow of the cooling air. Thus, the efficiency of cooling the lead tabs 110 may be improved.

In order to reinforce fixation strength between the lead tab 110 and the cell 100, one end of the lead tab 110 may be welded to the interior of the cell 100.

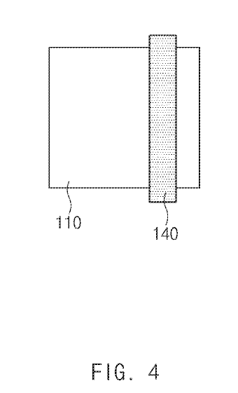

As illustrated in FIGS. 4 to 6, a sealing member 140 may be provided outside of the lead tab 110 to seal the cell 100 and the lead tab 110.

Meanwhile, the lead tabs 110 may be formed of positive and negative terminals 111 and 112, thereby allowing the cells 100 to form positive and negative electrodes, respectively.

In addition, the plurality of cooling holes 120 provided in the lead tabs 110 may be disposed in the same positions in the positive and negative terminals 111 and 112, thereby forming a heat dissipation path in the lead tabs 110 when the lead tabs 110 are cooled by the cooling air introduced through the duct 200. Thus, the efficiency of cooling the lead tabs 110 may be improved.

In order to optimize cooling performance, the width and length of the lead tab 110 and the shapes of the cooling holes 120 may be varied.

According to exemplary embodiments of the present disclosure, the cooling structure for a battery cell includes the plurality of stacked cells 100, the lead tabs 110 protruding outwardly from both ends of the cells 100 to form positive or negative electrodes, and the duct 200 disposed outside of the lead tabs 110 and providing the cooling air to the lead tabs 110 to cool the lead tabs 110. Unlike a conventional structure in which a cooling channel is formed between cells or a heat sink plate is provided between cells, the cooling holes 120 may be provided in the lead tabs 110 and the cooling air may be provided through the duct 200 to cool the lead tabs 110. By removing the heat sink plate and the cooling channel that are conventionally used, energy density with respect to the weight and volume of the battery structure may be increased. In addition, durability may be improved by stacking the cells and uniform temperature inside the cells may easily be managed. Therefore, marketability may be enhanced.

As set forth above, while the cooling performance in the battery structure for a vehicle may be maintained by cooling the lead tabs using the cooling air through the duct, durability may be improved by stacking the cells and energy density with respect to the weight and volume of the battery structure may be increased by removing the heat sink plate and the cooling channel that are conventionally used, and thus marketability may be enhanced.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A cooling structure for a battery cell, comprising:
a plurality of cells that are stacked;
lead tabs protruding outwardly from both ends of the cells to form positive or negative electrodes; and
a duct disposed outside of the lead tabs and providing cooling air to the lead tabs to cool the lead tabs.

2. The cooling structure for a battery cell according to claim 1, wherein the plurality of cells are attached to each other to form a parallel structure.

3. The cooling structure for a battery cell according to claim 2, wherein the lead tabs include a plurality of cooling holes so as to introduce the cooling air introduced through the duct to the lead tabs.

4. The cooling structure for a battery cell according to claim 3, wherein the cooling holes have a quadrangular shape, and
a guide is provided in a direction in which the cooling air moves.

5. The cooling structure for a battery cell according to claim 1, wherein one end of the lead tab is welded to the interior of the cell, and
a sealing member is provided outside of the lead tab to seal the cell and the lead tab.

6. The cooling structure for a battery cell according to claim 3, wherein the lead tabs are formed of positive and negative terminals.

7. The cooling structure for a battery cell according to claim 6, wherein the plurality of cooling holes are disposed in the same positions in the positive and negative terminals to form a heat dissipation path using the cooling air introduced through the duct.

8. A cooling structure for a battery cell, comprising:
a plurality of cells that are stacked;
lead tabs protruding outwardly from both ends of the cells to form positive or negative electrodes and including a plurality of cooling holes; and
a duct disposed outside of the lead tabs and providing cooling air to the cooling holes of the lead tabs to form a heat dissipation path and cool the lead tabs.
